(19) United States
(12) Patent Application Publication
(10) Pub. No.: US 2024/0347030 A1
(43) Pub. Date: Oct. 17, 2024

(54) SOLID-BODY STRUCTURE

(71) Applicant: RUAG Ammotec AG, Thun (CH)

(72) Inventor: Donald Meyer, Grolley (CH)

(73) Assignee: RUAG Ammotec AG, Thun (CH)

(21) Appl. No.: 18/044,843

(22) PCT Filed: Sep. 16, 2021
(86) PCT No.: PCT/EP2021/075469

§ 371 Date: Mar. 10, 2023

(30) Foreign Application Priority Data
Sep. 16, 2020 (DE) 102020124176.3

(51) Int. Cl. G10K 11/16; F01N 13/00; F41A 21/30

(52) U.S. Cl. CPC G10K 11/16; F01N 13/007; F41A 21/30

(57) ABSTRACT

A solid body structure may be connected to or support a structure-borne sound source. The solid body structure may have two structure-borne sound wave impact edges which extend in a direction of structure-borne sound wave propagation. The impact edges may, for example, approach one another and/or may be convex at least in sections in the direction of the structure-borne sound wave propagation. The solid body structure may be an engine cowling, a weapon component (e.g., a barrel or a silencer), or another acoustically effective structure.

### CROSS REFERENCE TO RELATED APPLICATIONS

This patent application is a U.S. national stage application of PCT International application No. PCT/EP2021/075469, filed Sep. 26, 2021, which claims priority to German Patent Application No. 10 2020 124 176.3, filed Sep. 16, 2020. Each of these applications is incorporated herein by reference in its entirety.

### BACKGROUND

### Field

The present disclosure relates to a solid body per structure, such as an engine cowling, a weapon component, in particular a barrel or a silencer, or any other acoustically active structure.

### Related Art

Vibration damping elements are of more interest than ever, as noise has become one of the main causes of disease. For example, the risk of heart disease increases with road noise from 40 dBA, and with aircraft noise from about 47 dBA. Expensive and partly controversial noise protection constructions already exist.

From EP 2 578 802 A1, an infinitesimally thin tapered turbine blade is known in which the propagating body sound waves are to be damped without impairing the aerodynamics of the turbine blade. The wedge-shaped vibration damping structure of the turbine blade uses the effect of so-called acoustic black holes. In particular, this is achieved by having a thickness h(x) of the turbine blade at a distance x from an imaginary line outside an outer edge h(x)=ε* xⁿ (where ε is a positive constant and n is a real number of 1 or more).

The problem with such a structure, however, is the technical feasibility and implementation to produce the infinitesimally thin turbine blade tips. Furthermore, the infinitesimally thin turbine blade tips are susceptible to damage. Furthermore, there is a high probability of injury to third parties. The infinitesimally thin turbine blade structure can be reduced by additionally using a damping layer and applying it to the thin-tapered turbine blade ends. However, the dimensions of the thin-tapered turbine blade ends are still significantly too small to be able to manufacture them economically and at the same time ensure sufficient stability of the turbine blade ends.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a solid body structure according to an exemplary embodiment of the disclosure.

FIG. 2 a solid body structure according to an exemplary embodiment of the disclosure.

FIG. 3 a solid body structure according to an exemplary embodiment of the disclosure.

FIG. 4 a solid body structure as a chevron according to an exemplary embodiment of the disclosure.

FIG. 5 a solid body structure as a rotor blade according to an exemplary embodiment of the disclosure.

FIG. 6 a solid body structure as a silencer according to an exemplary embodiment of the disclosure.

FIG. 7 a solid body structure as a firearm barrel according to an exemplary embodiment of the disclosure.

FIG. 8 a solid body structure as a sound-absorbing panel according to an exemplary embodiment of the disclosure.

The exemplary embodiments of the present disclosure will be described with reference to the accompanying drawings. Elements, features and components that are identical, functionally identical and have the same effect are-insofar as is not stated otherwise-respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

An object of the present disclosure is to overcome the disadvantages of the known prior art, in particular to provide a solid body structure with improved structure-borne noise reduction, which may be produced more economically.

Aspects of the disclosure provide a solid body structure, such as an engine cowling, a weapon component, in particular a barrel or a silencer, or another acoustically effective structure, in particular for sound insulation and/or sound damping measures. The solid body structure may have a shape deviating from a planar extension, in particular be three-dimensionally shaped. The solid body structure according to the disclosure can be designed in such a way that it acts as a sound insulation and/or sound damping component, in particular has a higher sound insulation and/or sound damping compared to surrounding components or components connected thereto. The sound attenuation measure in decibels (dB) may be used as a measure of the sound attenuation effect of the solid structure. The sound insulation effect can also be indicated by the decay rate, also known as reverberation time, which describes how quickly structure-borne sound decays in a solid.

The solid body structure according to the disclosure is connected to or supports a structure-borne sound source. In the case where the solid body structure forms an engine cowling, for example, the structure-borne sound source may be implemented by the engine. In the case where the solid body structure is, for example, a firearm component, such as a barrel or a silencer, the firing of the firearm forms the structure-borne sound source. The solid body structure according to the disclosure is particularly advantageous to use when the sound source emits short duration sound pulses, for example in defense applications. The firing of a firearm can be mentioned as an example. In general, the structure-borne sound source causes a structure-borne sound, i.e. sound that propagates in the solid structure. The propagation direction of the structure-borne sound is referred to in the following as the structure-borne sound wave propagation direction.

Furthermore, according to one aspect of the present disclosure, the solid body structure according to the disclosure comprises two structure-borne sound wave impact edges extending in a direction of structure-borne sound wave propagation and approaching each other. The structure-borne sound wave impact edges may end in each other, in particular forming a tip. For example, the tip has a radius of at most 0.1 mm. For example, a tip radius of 0.01 mm can be used as a manufacturability limit. On the one hand, the sound wave impact edges tapering so thinly towards each other can still be manufactured and, on the other hand, they offer a high sound reduction index and/or a low decay rate. The structure-borne sound wave impact edges can, at least in sections, form an outer contour of the solid body structure and/or face the surroundings. In standard solid body structures, the structure-borne sound leaves the solid body structure at the structure-borne sound wave impact edges, causing the structure-borne sound to propagate into airborne sound. By shaping the structure-borne sound wave impact edges according to the disclosure, the propagation of the structure-borne sound the surrounding air can be reduced, in particular avoided. According to one aspect of the present disclosure, this is achieved by the structure-borne sound wave impact edges being convexly shaped at least in sections as viewed in the direction of structure-borne sound wave propagation. The inventors of the present disclosure have found that the convex shape of the structure-borne sound wave impact edges results in a particularly good sound attenuation and/or a low decay rate. This is related, among other things, to the fact that as a result of the convex shape of the structure-borne sound wave impact edges, a high degree of structure-borne sound is reflected at the structure-borne sound wave impact edges and is prevented from propagating into the surrounding air. Another advantage is that the structure-borne sound wave impact edges may be further configured such that the structure-borne sound reflected at the structure-borne sound wave impact edges cancels each other out. Here, the solid body structure can make use of destructive interference.

In an exemplary embodiment of the solid body structure according to the disclosure, the structure-borne sound wave impact edges have the same radius of curvature at least in sections. In particular, the section with the same radius of curvature of the structure-borne sound wave impact edges is at the same height with respect to the structure-borne sound wave propagation direction. This increases the mutual cancellation effect of the reflected structure-borne sound waves.

In another exemplary embodiment of the present disclosure, the structure-borne sound wave impact edges are formed symmetrically with respect to a central axis oriented in the direction of structure-borne sound wave propagation. For example, a prong of the solid body structure formed by the two structure-borne sound wave impact edges is formed symmetrically with respect to the central axis. The solid body structure may have a plurality of such-formed prongs, each two adjacent prongs being connected to each other by means of a structure-borne sound wave deflection edge. The plurality of solid body structure prongs may extend in a common plane or deviate from a planar extension to form a three-dimensional component, for example be hollow cylindrical in cross-section or form a different type of three-dimensional structure. In this way, it is possible to advantageously use the solid body structure according to the disclosure for any application in which a high degree of sound insulation and/or sound attenuation is desired or required.

According to an exemplary further embodiment of the solid body structure according to the disclosure, the structure-borne sound wave impact edges are shaped to form an anti-noise device. Accordingly, the structure-borne sound wave impact edges may be shaped to make use of destructive interference. The design of the solid structure, in particular the structure-borne sound wave impact edges, purely by virtue of the geometric design, enables sound wave compensation equivalent to an anti-noise device in which a sound is normally actively, artificially, generated to effect destructive interference. According to the disclosure, there is no need for such an active, artificial sound generator. For example, the structure-borne sound wave impact edges are shaped in such a way that structure-borne sound is reflected by the structure-borne sound wave impact edges in such a way that the reflected structure-borne sound is mutually reduced, in particular mutually cancelled, in particular in the region of a central axis oriented in the structure-borne sound wave propagation direction between the structure-borne sound wave impact edges. The reflection of the structure-borne sound at the structure-borne sound wave impact edges has the effect that the structure-borne sound does not escape into the surroundings and can continue there. As a result of the cancellation of the structure-borne sound waves within the solid body structure according to the disclosure, the structure-borne sound is thus annihilated, so that a high degree of sound barrier of the solid body structure is achieved.

In an exemplary further development of the solid body structure, a distance h (x) of the structure-borne sound wave impact edges transverse to the structure-borne sound wave propagation direction, i.e. a thickness of the solid body structure, in particular a thickness of a tooth formed by the structure-borne sound wave impact edges, at a distance x from an imaginary line oriented transversely, in particular perpendicularly, to the structure-borne sound wave propagation direction outside the solid body structure is h(x)=2*c*xⁿ). E and m here relate to real numbers, so-called multiplication factors. A particularly advantageous solid structure results if the factor m lies in the range from 2 to 3.5 and the factor e in the range from 25 to 50. The multiplication factors e and m are to be regarded as dimensionless and unitless, respectively. For example, the distance x and thickness h (x) are expressed in meters. The power factor m according to the above equation thereby exponentiates the absolute value x, not its unit. In an exemplary embodiment, the distance h (x), i.e. the thickness of the tine, is in the range of 20 mm to 80 mm. For example, a dimension considered in the direction of propagation of the structure-borne sound waves, in particular the length, of the edges of the structure-borne sound waves or of the jag formed by them can lie in the range from 80 mm to 120 mm.

In another exemplary embodiment of the solid body structure according to the disclosure, the two structure-borne sound wave impact edges open into a common tip. The tip may be concavely curved as viewed in the direction of propagation of the structure-borne sound waves. For example, the tip has a radius of at most 0.1 mm. For example, a tip radius of 0.01 mm can be used as a manufacturability limit. On the one hand, the sound wave impact edges tapering so thinly towards each other can still be manufactured and, on the other hand, they offer a high degree of sound insulation, so that the solid body structure is particularly well suited for acoustically effective structures, such as also a firearm barrel or also a silencer.

According to a further aspect of the present disclosure, which can be combined with the preceding aspects and exemplary embodiments, a solid body structure, such as an engine cowling, a weapon component, in particular a barrel or a silencer, or another acoustically effective structure, in particular for sound insulation and/or sound damping measures, is provided. The solid body structure may have a shape deviating from a planar extension, in particular it may be three-dimensionally shaped. The solid body structure according to the disclosure can be designed in such a way that it acts as a sound-insulating and/or sound-damping component, in particular has a higher sound insulation and/or sound damping compared to surrounding components or components connected thereto. A degree of sound-damping in decibels (dB) can be used as a measure of the sound insulation effect of the solid body structure.

The solid body structure according to the disclosure is connected to or supports a structure-borne sound source. In the case where the solid body structure forms an engine cowling, for example, the structure-borne sound source may be implemented by the engine. In the case where the solid body structure is, for example, a firearm component, such as a barrel or silencer, the firing of the firearm forms the structure-borne sound source. In general, the structure-borne sound source causes a structure-borne sound, that is, sound that propagates in the solid body structure. The direction of propagation of the structure-borne sound is referred to below as the structure-borne sound wave propagation direction.

The solid body structure according to the disclosure comprises a structure-borne sound wave deflection edge and two structure-borne sound wave impact edges extending in a direction of a structure-borne sound wave propagation direction away from the structure-borne sound wave deflection edge. In other words, the structure-borne sound wave impact edges may terminate in a common structure-borne sound wave deflection edge. The structure-borne sound wave impact edges may, at least in sections, form an outer contour of the solid body structure and/or face the environment. In standard solid body structures, the structure-borne sound leaves the solid body structure at the structure-borne sound wave impact edges, causing the structure-borne sound to propagate into airborne sound. By shaping the structure-borne sound wave impact edges according to the disclosure, the propagation of the structure-borne sound to the surrounding air can be reduced, in particular avoided.

According to the further aspect of the present disclosure, the structure-borne sound wave impact edges extend away from the structure-borne sound wave deflection edge in the direction of the structure-borne sound wave propagation direction such that they delimit an at least partially concave airborne sound space. The airborne sound space can be understood as that area of the environment located between and delimited by the structure-borne sound wave exit edges. The structure-borne sound propagating from the structure-borne sound source first encounters and is redirected at the structure-borne sound wave deflection edge, and finally propagates further along the structure-borne sound wave propagation direction in the solid structure along the structure-borne sound wave impact edges. A reflection of the structure-borne sound can accompany at the structure-borne sound wave impact edges.

According to an exemplary further development of the solid body structure according to the disclosure, the structure-borne sound wave deflection edge is convexly shaped with respect to a structure-borne sound wave propagation direction. The convex shape of the sound wave deflection edge can provide a particularly high degree of structure-borne sound reflection.

In another exemplary embodiment of the solid body structure according to the disclosure, the structure-borne sound wave deflection edge has a radius of at most 0.1 mm. For example, a manufacturability limit of the convexly curved structure-borne sound wave deflection edge may be 0.01 mm.

According to a further exemplary embodiment of the solid body structure according to the disclosure, at least one of the structure-borne sound wave impact edges in an end portion considered with respect to the structure-borne sound wave propagation direction and/or the common tip of the structure-borne sound wave impact edges is provided with a damping and/or insulating layer. The damping layer can be made of any material suitable for sound insulation and/or sound damping. For example, this may be polymer-based. For example, the damping and/or insulating layer can have a layer thickness in the range from 0.05 mm to 1 mm.

The damping layer brings about a further improvement in the sound absorption coefficient. The inventors of the present disclosure have found that by means of the application of the damping or insulating layer it is possible to compensate for the disadvantage that infinitesimally thin solid structures cannot be produced which would prove to be optimal in terms of sound insulation and/or sound damping. By combining the solid body structure according to the disclosure with an applied damping or insulating layer, on the one hand the manufacturability of the solid body structure can be ensured and, on the other hand, a very high sound reduction index and/or a low decay rate can nevertheless be achieved.

According to an exemplary further development of the present disclosure, the damping and/or insulating layer is applied along at least one third of a total length, considered in the direction of propagation of structure-borne sound waves, of the corresponding structure-borne sound wave impact edge. It was found that it is not absolutely necessary to cover the entire structure-borne sound wave impact edge with the damping and/or insulating layer. Application in the area of the tapered end section, which leads into the apex, already achieves a high degree of improvement in the sound reduction index. Furthermore, the damping and/or insulating layer can prevent injury to a person if the tapered prongs or tips are covered with the damping and/or insulating layer.

In another exemplary embodiment of the solid body structure according to the disclosure, the structure-borne sound wave impact edges are bent over to form a C-shape. It should be understood that due to the bending over, the structure-borne sound wave impact edges are not convexly curved in sections. An advantage of bending over the structure-borne wave impact edges is that injury to persons can be avoided, namely by the pointed tips of the prongs formed by the structure-borne wave impact edges no longer being directed outwardly, but being inclined so that the tip no longer faces directly toward the surroundings and persons in the surroundings. For example, an end portion of the structure-borne sound wave impact edges adjoining a common tip of the structure-borne sound wave impact edges is oriented transversely, in particular substantially perpendicularly, to the structure-borne sound wave propagation direction (T).

In a further exemplary further development of the solid body structure according to the disclosure, a damping and/or insulating layer, in particular made of a polymer material or another suitable damping and/or sound-absorbing material, is inserted between the two structure-borne sound wave impact edges extending from the structure-borne sound wave deflection edge. In addition to an increased sound damping and/or sound attenuation effect, this is also accompanied by further protection against injury to persons, since the damping and/or sound attenuation layer is arranged in the region of the tapering end sections. For example, the damping and/or insulating layer is bonded to at least one structure-borne sound wave impact edge, in particular to both structure-borne sound wave impact edges.

In another exemplary embodiment of the solid structure according to the disclosure, an axial length of the structure-borne sound wave impact edges considered in the direction of structure-borne sound wave propagation is in the range of 80 mm to 120 mm. The axial length in combination with the geometrical design according to the disclosure and the thickness h (x) of the prongs or teeth formed by the structure-borne sound wave impact edges achieved as a result, an optimum sound reduction index and/or optimum decay rate can be achieved for any solid body structures designed and/or used.

In another exemplary embodiment of the solid body structure according to the disclosure, the solid body structure comprises a plurality of pairs of solid wave impact edges, wherein each two adjacent pairs of solid wave impact edges are connected to each other by means of a solid wave deflection edge. This results in a sequence of solid body structure prongs. For example, the solid body structure can be formed hollow-cylindrical in cross-section in the region of the pairs of structure-borne sound wave impact edges. Such a design is particularly suitable for rotationally symmetrical solid structures, such as a firearm barrel, a silencer or a chevron of an aircraft.

According to an exemplary further development of the present disclosure, a pair of structure-borne sound wave impact edges each forms a prong and the prongs are bent over in the direction of an adjacent prong in such a way that a structure-borne sound wave impact edge of one pair comes into contact with a structure-borne sound wave impact edge of an adjacent pair. Furthermore, a damping and/or insulating layer can be inserted, in particular glued in, between the bent-over, mutually facing structure-borne sound wave impact edges. It is clear that the impact edges of the structure-borne sound waves do not touch each other directly, but are connected to each other via the damping and/or insulating layer.

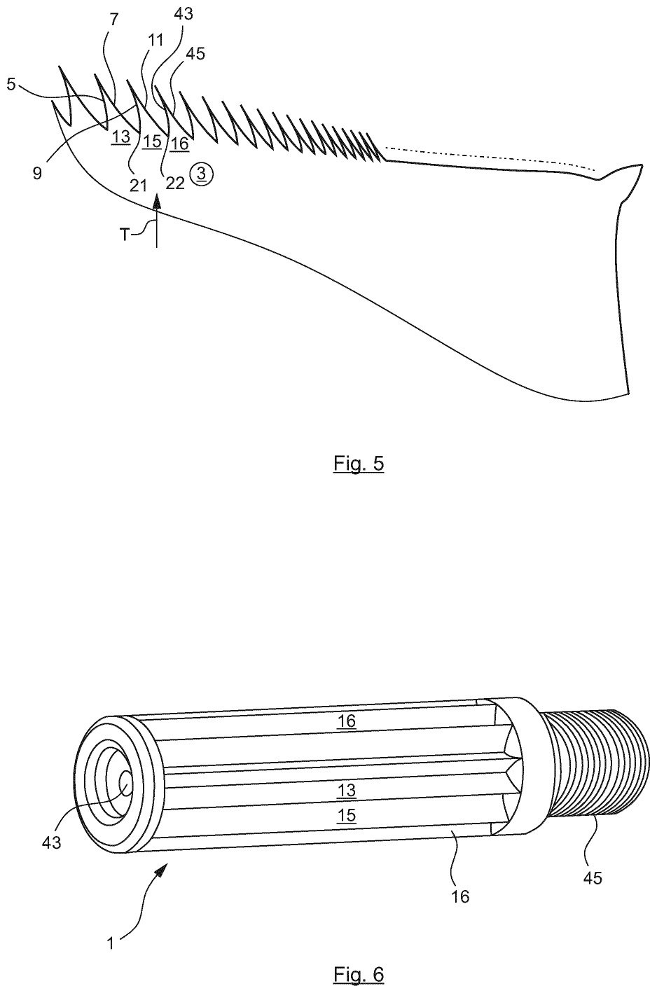

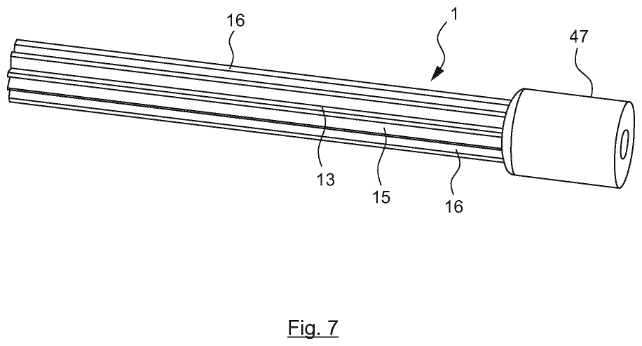

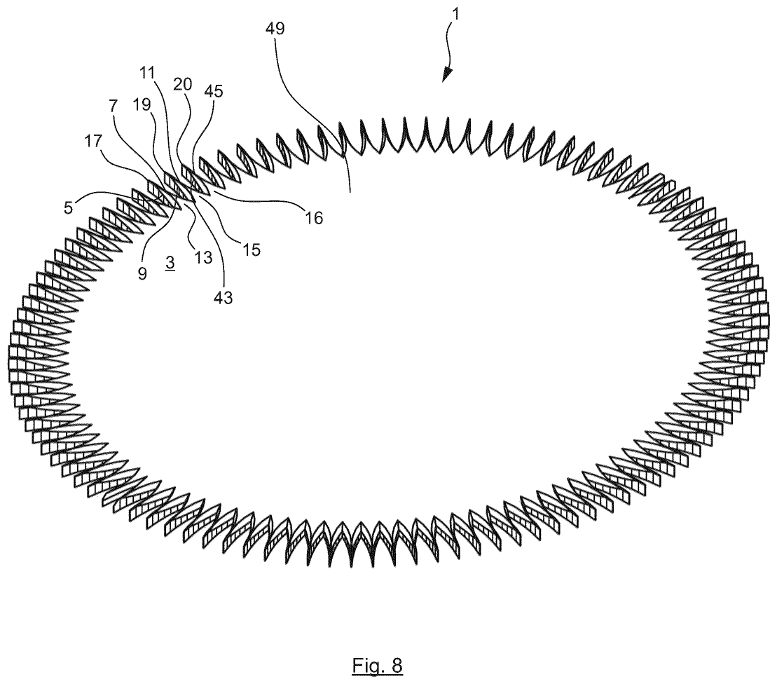

In the following description of exemplary embodiments of solid body structures according to the disclosure, which are generally provided with the reference numeral 1, on the basis of the accompanying figures, the constructive design of solid body structures 1 according to the disclosure is illustrated and their mode of action with regard to structure-borne sound insulation and/or structure-borne sound damping is explained. FIGS. 1 to 3 show exemplary designs of solid body structures 1 according to the disclosure in a plan view and as a partial view. FIGS. 4 and 7 show exemplary embodiments of solid body structures 1 according to the disclosure in perspective view, as a chevron (FIG. 4), as a rotor blade (FIG. 5), as a silencer (FIG. 6), as a gun barrel (FIG. 7) and as a sound-absorbing plate (FIG. 8).

FIG. 1 shows a section of an exemplary embodiment of a solid body structure 1 according to the disclosure, which can be used for any solid body structures in which a high degree of structure-borne sound insulation and/or structure-borne sound attenuation is desired. Such solid body structures may be referred to as acoustically effective structures. The solid body structure 1 carries or is connected to a structure-borne sound source indicated by reference numeral 3. The structure-borne sound source emits sound continuously or discontinuously, which propagates in the form of structure-borne sound waves in the solid body structure 1 and defines therein a structure-borne sound wave propagation direction T. It should be understood that in the course of the structure-borne sound wave propagation, the structure-borne sound wave propagation direction may well deviate from the original main structure-borne sound wave propagation direction T, for example, when the structure-borne sound impinges on obstacles such as structure-borne sound impact or deflection edges or the like.

Furthermore, the solid body structure 1 comprises several, according to FIG. 1 altogether four, structure-borne sound wave impact edges 5, 7, 9, 11. Each two adjacent structure-borne sound wave impact edges 5, 7, resp. 9, 11 form a prong or tooth 13 resp. 15 of the solid body structure 1. This is achieved by the fact that the two adjacent structure-borne sound wave impact edges 5, 7, resp. 9, 11, each forming a pair of structure-borne sound wave impact edges, extend in the direction of structure-borne sound wave propagation T and approach each other to form a common peak 17 and 19, respectively, into which the two structure-borne sound wave impact edges 5, 7 and 9, 11, respectively, open. According to one aspect of the present disclosure, the structure-borne sound wave impact edges 5, 7, 9, 11 are convexly shaped at least in sections as viewed in the direction of propagation of the structure-borne sound waves T. In the exemplary embodiment of the solid body structure 1 according to the disclosure illustrated in FIG. 1, the structure-borne sound wave impact edges 5, 7, 9, 11 are convexly shaped substantially along their full longitudinal extent.

Furthermore, solid wave impact edges 5, 7, 9, 11 are formed symmetrically with respect to a center axis M between them. This means that the solid structure prongs 13 and 15 formed by the solid wave impact edges 5, 7 and 9, 11, respectively, are formed axially symmetrically with respect to the center axis M. Due to the geometric formation of the solid body structure prongs 13, 15, the structure-borne sound propagating from the structure-borne sound source 3 is damped and/or attenuated as best as possible in the prongs 13, 15, in particular cancelled out. The convex shaping of the structure-borne sound wave impact edges 5, 7, 9, 11 ensures that the structure-borne sound is reflected particularly effectively by the structure-borne sound wave impact edges 5, 7, 9, 11. The reflection takes place in particular in such a way that the structure-borne sound reflected in each case by two adjacent structure-borne sound wave impact edges 5, 7 or 9, 11 of a pair of structure-borne sound wave impact edges is mutually reduced, in particular cancelled, in particular in the region of the central axis M between the adjacent structure-borne sound wave impact edges 5, 7 or 9, 11. In this way, the sound, in particular airborne sound, ultimately propagating into the environment surrounding the solid body structure 1, for example air, can be greatly minimized, so that the solid body structure 1 has a high sound reduction index (in decibels). Accordingly, the prongs 13, 15 can act as a passive anti-noise device.

The two prongs 13, 15 are connected to each other by means of a common structure-borne sound wave deflection edge 21. In other words, starting from the structure-borne sound wave deflection edge 21, which is oriented in the direction of the structure-borne sound source 3, two structure-borne sound wave impact edges 7, 9 extend in the direction of the structure-borne sound wave propagation direction T. The two structure-borne sound wave impact edges 7, 9 extending from the structure-borne sound wave deflection edge 21 are part of two adjacent solid structure prongs 13, 15 and two adjacent structure-borne sound wave impact edge pairs 5, 7 and 9, 11, respectively.

According to a further aspect of the disclosure, the structure-borne sound wave impact edges 7, 9 extend away from the structure-borne sound wave deflection edge 21 in the direction of the structure-borne sound wave propagation direction T in such a way that an at least partially concave airborne sound space 23 is delimited by the structure-borne sound wave impact edges 7, 9. According to FIG. 1, the airborne sound space 23 is substantially completely concave in shape. The structure-borne sound wave deflection edge 21, on the other hand, is convex with respect to the structure-borne sound wave propagation direction T and has a radius of at most 0.1 mm.

The embodiment of the solid body structure 1 according to FIG. 1 further comprises a further measure for improving the sound damping dimension of the solid body structure 1. In the region of an end section 29, 31 of the structure-borne sound wave impact edges 5, 7, 9, 11 considered with respect to the structure-borne sound wave propagation direction T, these are provided with a damping and/or damping layer 25. This is a thinly applied layer of material, for example based on polymers or another suitable sound damping and/or sound attenuating material, which is bonded, for example, to the structure-borne sound wave impact edges 5, 7, 9, 11. The damping and/or sound attenuating layer 25 is applied along at least one third of a total length of the corresponding structure-borne sound wave impact edge 5, 7, 9, 11 considered in the direction of structure-borne sound wave propagation T. The remaining section of the structure-borne sound wave impact edges 5, 7, 9, 11, which extends towards the structure-borne sound wave deflection edge 21, can be free of a damping and/or insulating layer 25.

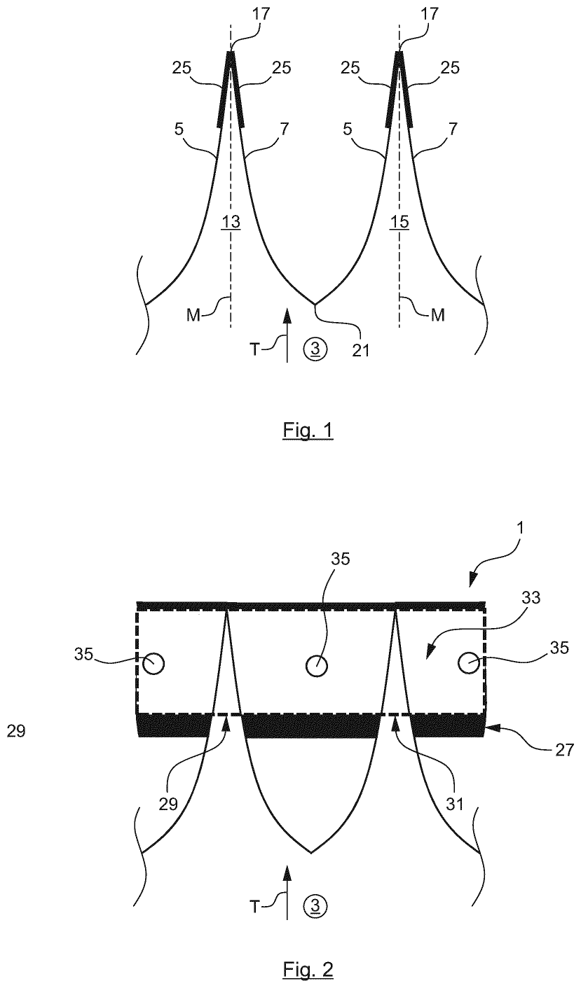

The design of the solid body structure 1 according to FIG. 2 differs from the solid body structure 1 according to FIG. 1 essentially in the additional damping and/or insulating layer 27 applied, which, unlike in FIG. 1, in which the damping and/or insulating layer 25 is applied locally, specifically to the end sections of the structure-borne sound wave impact edges 5, 7, 9, 11, is realized as a planar damping and/or insulating layer mat 27. In all other respects, the solid structure prongs 13, 15 are formed substantially as in FIG. 1. In contrast to FIG. 1, the end portions 29 or 31 of the solid body structure prongs 13 or 15 are recessed or inserted into the damping and/or insulating layer mat 27 over at least one third of an overall axial extension of the prongs 13, 15. Except for the recesses for the end portions 29, 31 of the prongs 13, 15, the damping and/or intumescent mat 27 is substantially continuous and connects the adjacent prongs 13, 15 to each other. As in the embodiment according to FIG. 1, the tip 17, 19 of the prongs 13, 15 may have a radius of at most 0.1 mm.

In the embodiment according to FIG. 2, it is further provided that a protective cover 33 is applied to the damping and/or insulating layer mat 27 from the outside, at least on one side, in particular from both sides. For example, the protective cover 33 may be screwed to the damping and/or insulating layer mat 27, which is indicated via the reference signs 35. It should be understood that in the event that a protective cover 33 is provided on both sides of the damping and/or insulating layer mat 27, the two protective covers 33 are screwed together.

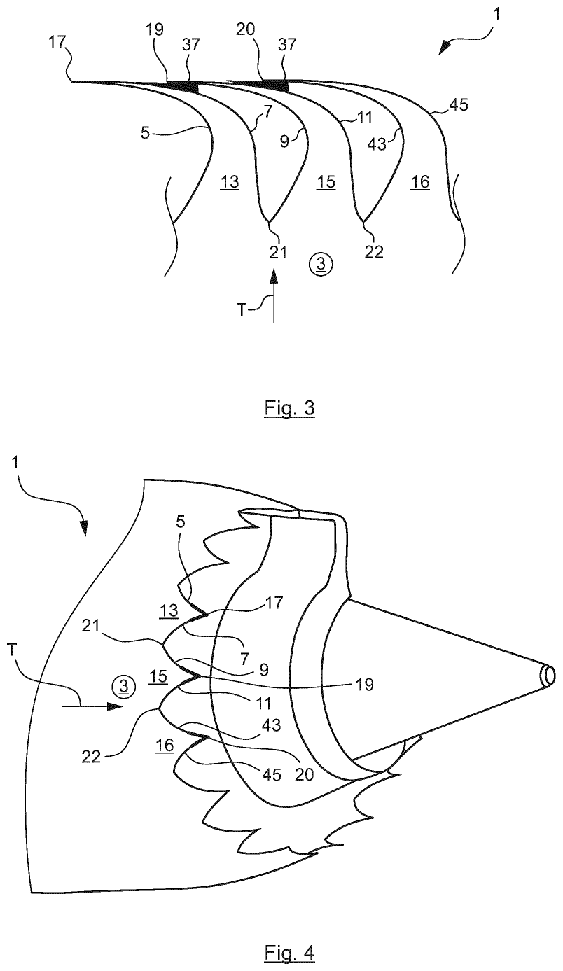

FIG. 3 illustrates another exemplary embodiment of a solid body structure 1 according to the disclosure, which is basically similar to the preceding embodiments. In FIG. 3, the solid body structure 1 has three adjacent solid body structure prongs 13, 15, 16, the third prong 16 likewise being formed by two solid body wave impact edges 13, 15 formed substantially analogously to the other solid body wave impact edges 5, 7, 9, 11, which open into a common seat 20. The structure-borne sound wave impact edge 13 adjacent to the jag 15 opens with the structure-borne sound wave impact edge 11 of the jag 15 into a common structure-borne sound wave deflection edge 22, which can be shaped in accordance with the structure-borne sound wave deflection edge 21.

The prongs 13, 15, 16 are bent over in the direction of an adjacent prong according to FIG. 3. It can be seen that the prongs are bent over to such an extent that an end section of the prongs 13, 15, 16 opening into the respective tip 17, 19, 20 of the prongs 13, 15, 16 is oriented essentially perpendicular to the direction T of propagation of structure-borne sound waves. Furthermore, the prongs 13, 15, 16 are bent over to such an extent that a slight free space is created between adjacent structure-borne sound wave impact edges 7, 9 or 11, 13 of two adjacent prongs 13, 15 or 15, 16. A damping and/or insulating layer 37 in the form of a wedge-shaped damping and/or insulating layer strip is introduced, in particular glued, into this free space. In this respect, the adjacent prongs 13, 15, 16 are connected to one another in the region of the end sections, i.e. near the tips 17, 19, 20.

FIGS. 4 and 5 show exemplary embodiments of the solid body structures 1 as a chevron 39 of an aircraft (FIG. 4) and once as a rotor blade 41 of, for example, a helicopter or an airplane. It can be seen that the solid body structure 1 according to the disclosure is also particularly well suited for three-dimensional components.

Further exemplary embodiments of solid body structures 1 according to the disclosure are illustrated in FIGS. 6 to 8, with FIGS. 6 and 7 relating to weapon technology. FIG. 7 shows the solid body structure 1 as a silencer with a front opening 43, via which the projectile leaves the silencer 1, and a rear fastening device 45, in particular an external thread, for connection to the muzzle of a firearm (not shown). Viewed in the direction of firing, the silencer outer jacket is formed in sections by the solid body structure 1 according to the disclosure, which extends in a jacket-like and rotational manner around the fetch interior. In this respect, the solid body structure 1 forms a closed annular structure which, viewed in the axial direction, is of constant shape. In an analogous manner, the embodiment of the solid body structure 1 on the firearm barrel in FIG. 7 is to be understood, in which the solid body structure 1 forms the firearm barrel jacket behind the front muzzle 47 of the firearm not shown. In both the silencer solid body structure 1 in FIG. 6 and the firearm solid body structure 1 according to FIG. 7, the sound source 3 is realized by the firing of the projectile by means of the firearm. In this respect, a brief sound pulse results here. In this application, the solid body structure 1 according to the disclosure is particularly noticeable, since a significantly reduced decay rate or a significantly higher sound reduction index can be achieved compared to conventional silencers or firearm barrels. The sound pulse generated by the firing of the firearm is greatly attenuated or damped by means of the solid body structure 1 according to the disclosure.

The design of the solid structure 1 according to FIG. 8 represents a planar sound insulation panel of certain material thickness, whose circumferential edge has a high sound reduction index and a low decay rate due to the structural measures of the solid structure 1. For example, center region 49 is connected to or supports sound source 3 (not shown). The structure-borne sound propagating from the sound source 3 runs distributedly into the prongs 13, 15, 16 and is particularly effectively damped or attenuated there.

The features disclosed in the foregoing description, figures, and claims may be significant both individually and in any combination for the realization of the disclosure in the various embodiments.

### REFERENCE LIST

1 Solid body structure
3 Structure-borne sound
5, 7, 9, 11, 43, 45 structure-borne sound wave impact edge
13, 15 Prong
17, 19, 20 Tip
21,22 Structure-borne sound wave deflection edge
23 Airborne Sound Chamber
25, 27, 37 Damping and/or insulating layer
29, 31 End section
33 Protective cover
35 Screw connection
39 Chevron
41 Rotor blade
43 Opening
45 Fastening device
47 Mouth
M Center axis
T Structure-borne sound wave propagation direction

1. A solid body structure, comprising:
two structure-borne sound wave impact edges extending in a direction of structure-borne sound wave propagation, and being adapted to approach one another, the two structure-borne sound wave impact edges being convex at least sectionally in the direction of the structure-borne sound wave propagation,
wherein the solid body structure is adapted to connect to or support a structure-borne sound source.

2. The solid body structure according to claim 1, wherein the structure-borne sound wave impact edges have, at least sectionally, a same radius of curvature.

3. The solid body structure according to claim 1, wherein the structure-borne sound wave impact edges are formed symmetrically with respect to a center axis oriented in the direction of structure-borne sound wave propagation.

4. The solid body structure according to claim 1, wherein the structure-borne sound wave impact edges are shaped to form an anti-noise device.

5. The solid body structure according to claim 1, wherein a distance h(x) of the structure-borne sound wave impact edges transverse to the direction of structure-borne sound wave propagation at a distance x from an imaginary line oriented transversely to the direction of structure-borne sound wave propagation outside the solid body structure is h(x)=2×e×x^{m}, where e and m are real numbers.

6. The solid body structure according to claim 1, wherein the two structure-borne sound wave impact edges end in a common tip.

7. A solid body structure, comprising:
a structure-borne sound wave deflection edge; and
two structure-borne sound wave impact edges extending in a direction of structure-borne sound wave propagation away from the structure-borne sound wave deflection edge such that the two structure-borne sound wave impact edges delimit an at least partially concave airborne sound space, wherein the solid body structure is adapted to connect to or support a structure-borne sound source.

8. The solid body structure according to claim 7, wherein the structure-borne sound wave deflection edge is convexly shaped with respect to the direction of structure-borne sound wave propagation.

9. The solid body structure according to claim 7, wherein the structure-borne sound wave deflection edge has a radius of at most 0.1 mm.

10. The solid body structure according to claim 7, wherein at least one of the structure-borne sound wave impact edges, in an end portion and/or a tip of the at least one of the structure-borne sound wave impact edges with respect to the direction of structure-borne sound wave propagation comprises a damping layer and/or an insulating layer.

11. The solid body structure according to claim 10, wherein the damping layer and/or the insulating layer is disposed along at least one third of a total length, with respect to the direction of propagation of structure-borne sound waves, of the corresponding structure-borne sound wave impact edge.

12. The solid body structure according to claim 7, wherein the structure-borne sound wave impact edges are bent over to form a C-shape.

13. The solid body structure according to claim 12, wherein a damping layer and/or an insulating layer is disposed between the two structure-borne sound wave impact edges extending from the structure-borne sound wave deflection edge.

14. The solid body structure according to claim 7, wherein an axial length of the structure-borne wave impact edges, in the structure-borne wave propagation direction, is 80 mm to 120 mm.

15. The solid body structure according to claim 7, comprising a plurality of pairs of structure-borne sound wave impact edges, wherein each two adjacent pairs of structure-borne sound wave impact edges are connected to one another by a structure-borne sound wave deflection edge.

16. The solid body structure according to claim 15, wherein each pair of structure-borne sound wave impact edges forms a prong, the prongs being bent over in a direction of an adjacent prong such that a structure-borne sound wave impact edge of one pair comes into contact with a structure-borne sound wave impact edge of an adjacent pair.

17. The solid body structure according to claim 1, wherein the solid body structure is an engine cowling, a barrel of a firearm, or a silencer of a firearm.

18. The solid body structure according to claim 1, wherein the structure-borne sound wave impact edges are adapted to reflect structure-borne sound such that the reflected structure-borne sound is mutually reduced in a region of a central axis oriented in the direction of structure-borne sound wave propagation between the structure-borne sound wave impact edges.

19. The solid body structure according to claim 12, wherein an end portion of the structure-borne sound wave impact edges adjoining a common tip of the structure-borne sound wave impact edges is oriented transversely to the direction of structure-borne sound wave propagation.

20. The solid body structure according to claim 16, wherein:
the solid body structure is a hollow-cylindrical structure in cross-section in a region of the pairs of structure-borne sound wave impact edges; and
a damping layer and/or an insulating layer is disposed between the contacting structure-borne sound wave impact edges.
